(19) United States
(12) Patent Application Publication
(10) Pub. No.: US 2006/0033951 A1
(43) Pub. Date: Feb. 16, 2006

(54) Data processing device for deciding best print mode based on data characteristics and method thereof

(76) Inventors: Shih-Yen Chang, Taoyuan (TW); Chung-Hsing Li, Taoyuan (TW)

Correspondence Address: Hoffman, Warnick & D'Alessandro LLC, Three E-Comm Square, Albany, NY, 12207, US

(21) Appl. No.: 11/184,402

(22) Filed: Jul. 19, 2005

(30) Foreign Application Priority Data
Jul. 21, 2004 (TW) 093121752

(51) Int. Cl. G06F 15/00

(52) U.S. Cl. 358/1.15

(57) ABSTRACT

The present invention discloses a data processing device including a data processing unit and a data outputting unit. The data processing unit is used for receiving a transmitted data block and determining and generating a corresponding eigenvalue based on at least one data characteristic of the data block. The data outputting unit includes a plurality of print modes. The data outputting unit will print the data block in a print mode according to a print command transmitted from the data processing unit. The data processing unit calculates the eigenvalues with a set of corresponding weights to generate the print command accordingly, so that the data outputting unit can print the data block in the print mode according to the print command and, so as to avoid complex setting procedures in the user interface.

### BACKGROUND OF THE INVENTION

1. Field of the Invention

The present invention relates to a data processing device and method thereof, especially to a data processing device and method thereof, based on a data characteristic, for automatically deciding the best print mode. The present invention can be applied in a scanner, a printer, a fax, a multifunction printer, or the like.

2. Description of the Prior Art

Most of the conventional image processing devices, such as scanner, printer, fax, or multifunction printer, have various outputting functions, e.g. print or copy. For example, some scanners can capture the image of a document and print it out, and some printers can read the photos stored in the memory card and print it out in a photo mode. Furthermore, there are different print modes corresponding to different print quality in this kind of devices, such as a draft mode, a normal mode, a photo mode, a fast mode, or a best mode, for the user to choose. On the other hand, a user may also perform a selection during the setting procedure to obtain the desired print quality.

However, the user is not always satisfied with the print quality what they expected. Sometimes the default print mode or the print mode chosen by the user in the device does not fit the printing requirement. For example, when a user wants to print a picture, he/she always selects the normal mode to print it first. If the user isn't satisfied with the print quality, he/she will further select other print modes to obtain better print quality. On one hand, a user may perform a complex setting procedure to print the picture, but if the print quality is not satisfied with his/her expectation, the user has to repeat the same setting procedure for other print mode. On the other hand, a user may perform the setting procedure for black/white or color print but forget to set other related setting at the same time, and then he/she changes selection setting until numbers of papers have been printed out. Under the above-mentioned circumstances, the resource, such as papers, ink, or carbon powders, will be wasted a lot, and the user will waste much time on printing. It's really inconvenient for a user to print something.

Moreover, graphics and text may be included in the same document for a user to print. For example, a document may include two parts, wherein one-third part is made up of graphics and two-third part is made up of text. When a document including graphics and text is printed out in a fast mode, the print quality of the text may be good, but the print quality of the graphics may be bad. If a document including graphics and text is printed out in an optimum mode, the print quality of the graphics may be good, but lots of time may be wasted in printing text. There is still not an excellent solution for overcoming the above-mentioned problems.

In the conventional image processing devices, some of them can be operated by itself without connecting to a host computer. Therefore, a user can perform a simple setting procedure via the user interface of the device to select the print mode, the print size or the number of what he/she wants to print instead of performing a complex setting procedure on printing via the host computer. However, the user may still not feel satisfied with the print quality resulted from the print mode he/she selected, and it's time-consuming and resource-consuming. Also, the above-mentioned problem still occurs when a document including graphics and text is desired to be printed.

Therefore, the objective of the present invention is to provide a data processing device and method thereof, based on the data characteristic, for automatically deciding the best print mode, so as to solve the above-mentioned problems.

### SUMMARY OF THE INVENTION

The objective of the present invention is to provide a data processing device and method thereof, based on the data characteristic, for automatically deciding the best print mode. Thus, a user can print something with the best print quality without performing a complex setting procedure.

The data processing device of the present invention includes a data processing unit and a data outputting unit. The data processing unit is used for receiving a transmitted data block and generating a corresponding eigenvalue according to at least one data characteristic of the data block. The data outputting unit includes a plurality of predetermined print modes. The data outputting unit prints out the data block in a print mode according to a print command transmitted from the data processing unit. The data processing unit calculates the generated eigenvalues with a set of corresponding weights to automatically generate the print command, so that the data outputting unit prints out the data block in the print mode mandated by the transmitted print command.

The data processing method of the present invention is used for utilizing a data outputting unit to automatically print out a data block in one of a plurality of predetermined print modes. The data processing method of the present invention includes the steps of: (1) receiving at least one transmitted data block; (2) generating a corresponding eigenvalue based on at least one data characteristic of the data block; (3) calculating the generated eigenvalue with a set of corresponding weights to determine a print mode; and (4) generating a print command to make the data outputting unit print out the data block according to the print mode mandated by the print command.

The data processing device and method of the present invention can be used to automatically decide a print mode according to the data characteristics of the data block transmitted from a scanner, a printer, a fax, a computer, or the like. According to the data processing device and method of the present invention, different print commands can be issued based on different data blocks of the document and the different data blocks can be printed out in different print modes accordingly. The data processing device and method of the present invention can generate the best print mode automatically and accordingly based on the data characteristics of a document or a file, so as to avoid complex setting procedures on the user interface. Therefore, the data processing device and method of the present invention can avoid consuming print resources and wasting time in setting procedures. Accordingly, it's more convenient for the user and the best print mode can be obtained when the user wants to print something.

The advantage and spirit of the invention may be understood by the following recitations together with the appended drawings.

### BRIEF DESCRIPTION OF THE APPENDED DRAWINGS

FIG. 1 is a functional block diagram of the data processing device according to a preferred embodiment of the present invention.

FIG. 2 is a flowchart of an embodiment of the AutoType algorithm in the eigenvalue calculation procedure of the data processing device shown in FIG. 1.

FIG. 3 is a functional block diagram of the data processing device according to another embodiment of the present invention.

FIG. 4 is a schematic diagram of deciding a print mode according to the calculation result and the threshold by the data processing device shown in FIG. 3.

FIG. 5 is a flowchart of the data processing method according to the present invention.

FIG. 6 is a flowchart of the data processing method according to another embodiment of the present invention.

### DETAILED DESCRIPTION OF THE INVENTION

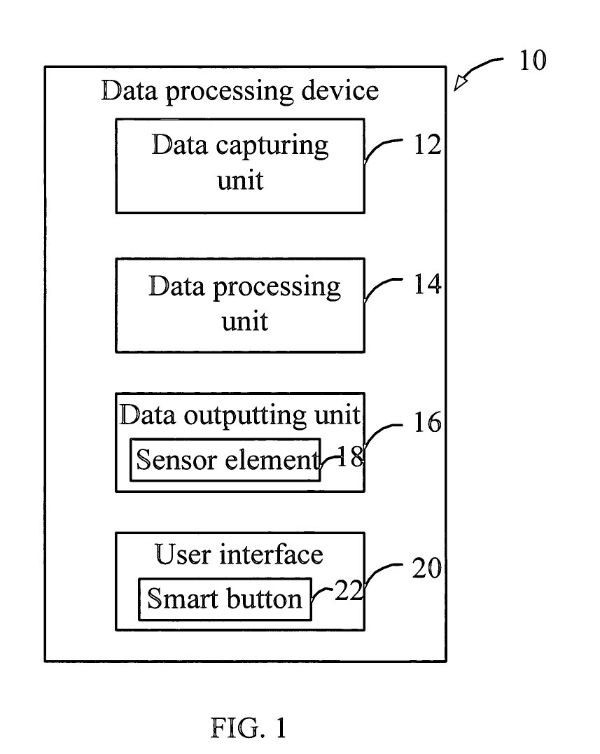

Please refer to FIG. 1. FIG. 1 is a functional block diagram of the data processing device 10 according to a preferred embodiment of the present invention. The data processing device 10 includes a data capturing unit 12, a data processing unit 14, and a data outputting unit 16. In different embodiments, the data processing device 10 can be a scanner, a printer, a fax, a multifunction printer, or a combination thereof.

The data capturing unit 12 is used for capturing a data block and for transmitting the data block to the data processing unit 14. The data processing unit 14 is used for receiving the data block transmitted from the data capturing unit 12 and for generating a corresponding eigenvalue according to at least one data characteristic of the data block. There is often one or more than one data characteristic in a data block. In an embodiment, the data characteristics include transmittance, chroma, or graphics-text ratio of the data block, and material of a printing paper. The data outputting unit 16 includes a plurality of predetermined print modes and prints out the data block in a print mode according to a print command transmitted from the data processing unit 14. The data processing unit 14 calculates the generated eigenvalues with a set of corresponding weights to automatically generate the print command, so that the data outputting unit 16 prints out the data block in the print mode mandated by the transmitted print command.

The data processing device 10 further includes a user interface 20 for receiving a selection setting inputted by a user. The user interface 20 includes a single smart button 22 and an automatic outputting function is activated when the smart button 22 is pressed without having to perform other settings in the user interface 20. In other words, when the automatic outputting function is activated after the smart button 22 is pressed by the user, it's unnecessary for the user to perform related setting procedure on transmittance, chroma, or graphics-text ratio of the data block, and material of a printing paper. Therefore, the data processing device 10 of the present invention provides a very convenient user interface for the user. In other words, the user only needs to press the smart button 22 to activate the automatic outputting function, and then the data processing device 10 will decide the best print mode automatically.

In an embodiment, the data capturing unit 12 can be a scanning module used for scanning and transforming a to-be-scanned document into at least one of the data blocks. The data outputting unit 16 can be a print module. When the automatic outputting function of the data processing device 10 is activated, the scanning module promptly scans and transforms the to-be-scanned document into the data block. The data processing unit 14 performs calculation on the data block to automatically generate the print command, so that the print module prints out the data block according to the print mode mandated by the print command and, so as to avoid complex setting procedures in the user interface 20 for the user. Therefore, when a user wants to print something, the data processing device 10 can decide the best print mode automatically after the automatic outputting function is activated.

The automatic outputting function of the data processing device 10 includes an eigenvalue calculation procedure and a weight calculation procedure. Based on transmittance, chroma, or graphics-text ratio of the data block, and material of the printing paper, the eigenvalue calculation procedure calculates the corresponding eigenvalue EVi (i=1˜N) respectively, wherein N represents the number of the eigenvalues. The weight calculation procedure calculates the corresponding weights Wi (i=1˜N) respectively based on the following first formula:

$$First formula : Wi = EVi / {\sum }_{i = 1}^{N} EVi .$$

In the above-mentioned weight calculation procedure, the weights Wi (i=1˜N) are calculated through the first formula. In other words, the weight is proportional to the eigenvalue. For example, when i=4, the four weights W1, W2, W3, and W4 are respectively proportional to the four eigenvalues EV1, EV2, EV3, and EV4. In another embodiment, the weights can be also obtained by average. For example, when i=4, the four weights W1, W2, W3, and W4 all are a quarter respectively. After the automatic outputting function is activated, based on the following second formula, the data processing device 10 will obtain a calculation result P corresponding to the data block.

$$Second formula : \\ P = {\sum }_{i = 1}^{N} Wi * EVi .$$

Afterward, the calculation result P is compared with at least one threshold to determine the print mode and generate the print command. The data processing unit 16 prints out the data block according to the print mode mandated by the print command.

Each of the print modes corresponds to different print quality. In an embodiment, these print modes are respectively a draft mode, a normal mode, and a photo mode from low print quality to high print quality. The calculation result P is compared with a first threshold and a second threshold to determine whether the data block should be printed out in the draft mode, the normal mode, or the photo mode. The thresholds can be predetermined according to the experimental results or experiences. In this embodiment, the draft mode, the normal mode, or the photo mode corresponding to the print quality from low to high can be discriminated from each other by comparing with the first threshold and the second threshold respectively.

As shown in FIG. 1, after the automatic outputting function of the data processing device 10 is activated, the data processing unit 14 can issue different print commands according to the data blocks with different calculation results P in the same to-be-scanned document, so that the data outputting unit 16 prints out the data blocks with different calculation results P in different print modes in a flexible manner. For instance, if one part of the to-be-scanned document is full of graphics and another part is full of text, the data capturing unit 12, i.e. a scanner, scans the document and transforms it into two corresponding data blocks. According to the two data blocks, the data processing unit 14 will figure out two calculation results P and issues two corresponding print commands, so that the data outputting unit 16 respectively prints out the two data blocks with different calculation results P in different print modes. Accordingly, based on the data characteristic of each data block, the data processing device 10 of the present invention can automatically print out different data blocks in the same document in different print modes in a flexible manner.

As shown in FIG. 1, the data outputting unit 16 further includes a photo sensor 18 for sensing the material of a print paper placed in the data outputting unit 16. If the material of the print paper fits the requirement of the print mode mandated by the print command, printing continues; otherwise, a notice message is prompted to warn the user to allow printing continuing or canceling. For example, according to the data processing device 10 and the automatic outputting function thereof, if the print mode mandated by the print command is a photo mode, and the print paper placed on the data outputting unit 16, i.e. a print module, is a print paper for the normal mode not for the photo mode, the photo sensor 18 will sense the material of the print paper and find that the material of the print paper does not fit the requirement of the photo mode. At this time, a notice message is prompted to warn the user to allow printing continuing or canceling. Certainly, based on the notice message, the user can replace the print paper for the normal mode by the print paper for the photo mode, and then allow printing continuing.

In an embodiment, the eigenvalue calculation procedure includes an AutoType algorithm for determining whether the data block is classified as color, gray, or black/white based on a preview image data of the scanning module. In the AutoType algorithm, a Lebesgue algorithm is further employed to determine whether the data block is classified as color based on a data density, and an Erosion algorithm is further employed to determine whether the data block is classified as gray or black/white according to the mathematical morphology theory for the image processing. The Lebesgue algorithm and the Erosion algorithm both are a well-known art respectively.

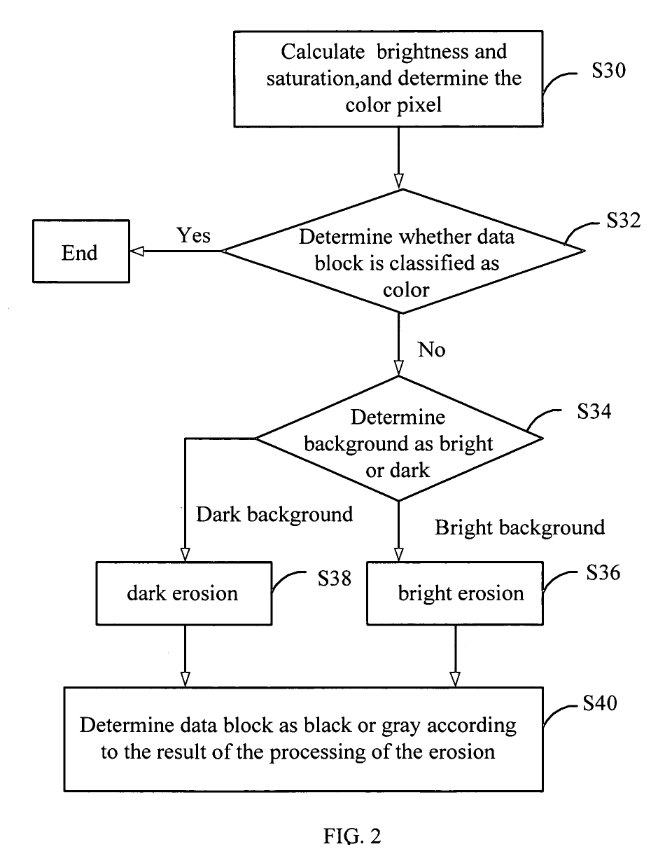

Please refer to FIG. 2. FIG. 2 is a flowchart of an embodiment of the AutoType algorithm in the eigenvalue calculation procedure of the data processing device 10 shown in FIG. 1. The following will describe the above-mentioned AutoType algorithm in detail together with the flowchart shown in FIG. 2. In an embodiment, at start, step S30 is performed to calculate the brightness and the saturation of each pixel in each data block of the image data, and determine the color pixel according to the brightness and the saturation, wherein the brightness is calculated by (R+G+B)/3, the saturation is calculated by [255−Min(R,G,B)/brightness], and the pixel is classified as color pixel while the brightness is greater than 50, and the saturation is greater than 40. In the above, the data for classifying the pixels is based on the experimental data.

Afterward, step S32 is performed. In step S32, whether the data block classified as color is determined based on the data density. The density mentioned in the above indicates the number of color pixels in a 3×3 mask. When the density is greater than or equal to seven, the data block is classified as color, otherwise the data block is not classified as color, and the data block continues to be classified as gray or black/white.

Step S34 is then performed. In step S34, whether the background is bright or dark will be determined. First, the value of the brightness is calculated to make a histogram, and then the number of the pixels of each interval with ten grids in the histogram is summed up. Afterward, look for an interval having the most pixels and set the brightness of the background as the middle value of the interval. If the brightness of the background is greater than 200, the background is regarded as a bright background and step S36 is then performed, otherwise the background is regarded as a dark background and step S38 is then performed.

In step S36, Max (W(q)) is substituted for q by the bright erosion, wherein q is the original brightness, and MaxW((q)) is the maximum value of q in the 3×3 mask.

In step S38, MinW((q)) is substituted for q by the dark erosion, wherein q is the original brightness, and MinW((q)) is the maximum value of q in the 3×3 mask.

Step S40 is then performed. In step S40, a new image data is obtained when all of the pixels have been processed. According to a brightness histogram corresponding to the new image data, the number of the pixels of each interval with fifteen grids in the histogram is summed up. When the number of pixels in an interval exceeds 90 percent of total pixels, the data block is determined as black/white, otherwise the data block is determined as gray.

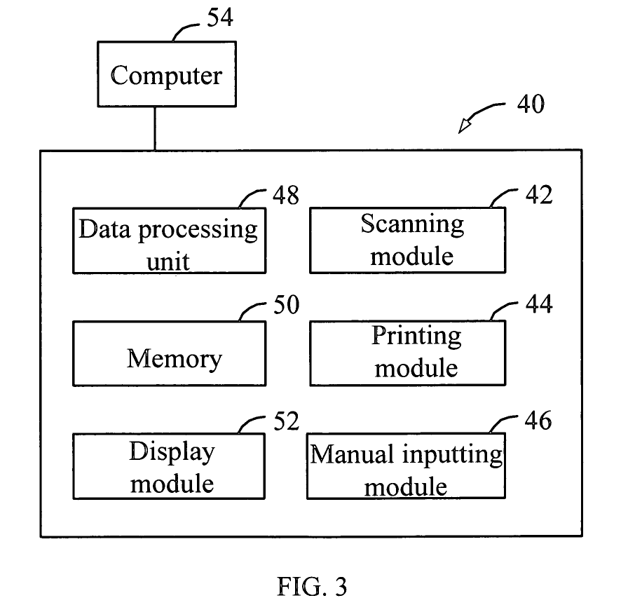

Please refer to FIG. 3. FIG. 3 is a functional block diagram of the data processing device 40 according to another embodiment of the present invention. In another embodiment, the data processing device 40 includes a scanning module 42, a print module 44, a manual inputting module 46, and a data processing unit 48. The data processing device 40 is connected to a host computer 54. The data processing device 40 has an automatic outputting function, and a user can determine whether the automatic outputting function should be activated. The user can also set the print mode by the manual inputting module 46 without activating the automatic outputting function. When the user activates the automatic outputting function, the data processing device 40 will automatically decide the best print mode based on the data characteristics of each data block in a flexible manner.

As shown in FIG. 3, the scanning module 42 is used for scanning a to-be-scanned document (not shown) and for transforming it into data blocks. The data processing unit 48 is used for receiving the data blocks transmitted from the scanning module 42 and for generating the corresponding eigenvalues. Due to the experimental result, the domain of the eigenvalues always falls into the interval from 1 to 10. The calculation of the eigenvalues is related to the algorithm and the optical module. The data processing unit 48 will generate the eigenvalues corresponding to the data block according to the data characteristic including transmittance, chroma, or graphics-text ratio of the data block and material of a print paper. In an embodiment, a to-be-scanned document includes both color images and text, and, according to the AutoType algorithm shown in FIG. 2, the data processing unit 48 can determine which data block is classified as color images and which data block is classified as text. Afterward, the data processing unit 48 calculates the generated eigenvalues with a set of corresponding weights and further generates the print command automatically. The print module 44 will print the document in the print mode mandated by the print command.

The automatic outputting function of the data processing device 40 includes an eigenvalue calculation procedure and a weight calculation procedure. According to these calculation procedures, a calculation result P will be obtained for determining the print mode. Each eigenvalue of a data block will be calculated after the data processing unit 48 receives the data block. In an embodiment, the calculated eigenvalue of the data block includes the eigenvalue of transmittance EV1, the eigenvalue of chroma EV2, the eigenvalue of graphics-text ratio EV3, and the eigenvalue of material of a print paper EV4. After these eigenvalues are calculated, the corresponding weights Wi (Wi ; i=1˜4) are calculated according to the above-mentioned first formula. Afterward, according the above-mentioned second formula, each eigenvalue is multiplied by the corresponding weight and each product will be summed up to obtain a calculation result P

$$( P = {\sum }_{i = 1}^{N} Wi * EVi ; N = 1 ∼ 4 ) .$$

The print mode is determined and the print command is also generated after comparing the calculation result P with the thresholds.

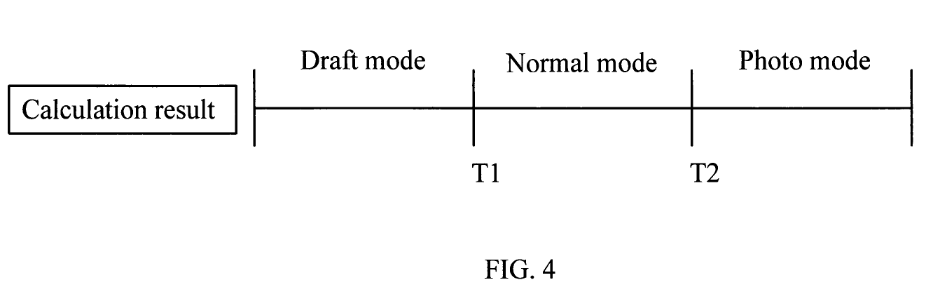

Please refer to FIG. 4. FIG. 4 is a schematic diagram of deciding a print mode according to the calculation result P and the threshold by the data processing device 40 shown in FIG. 3. In an embodiment, two thresholds T1 and T2 are respectively used to determine three print modes, wherein the draft mode is determined when the calculation result P is smaller than T1, the normal mode is determined when the calculation result P is larger than T1 and smaller than T2, and the photo mode is determined when the calculation result P is larger than T1. In the above-mentioned embodiment, a to-be-scanned document includes both color images and text. After the automatic outputting function is activated, two calculation results P1 and P2 of the data block respectively corresponding to the color image and the text will be calculated. After the two calculation results P1 and P2 are compared with the thresholds, the two calculation results PI and P2 respectively fall into the intervals corresponding to the draft mode and the normal mode. Accordingly, the print module 44 will print out the data blocks corresponding to the color image in the normal mode and print out the data blocks corresponding to the text in the draft mode. In another embodiment, based on different print quality, the data blocks can be printed out in other print modes corresponding to a plurality of intervals separated by different thresholds.

As shown in FIG. 3, the data processing device 40 further includes a memory 50 and a display unit 52. The memory 50 is used for storing the required program or data. In different embodiment, the display unit 52 can be a light emitting diode (LED) or a liquid crystal display (LCD). The data processing device 40 further includes a user interface (not shown in FIG. 3) having a single smart button. The user can activate the automatic outputting function by the single smart button. In an embodiment, the display unit 52 is an LCD, and all kinds of conditions or setting can be displayed on the display unit 52 via the user interface. For example, the user can perform all related setting procedure through the user interface or activate the automatic outputting function by the manual inputting module 46 through the smart button shown on the user interface. In an embodiment, the manual inputting module 46 is a keyboard.

As shown in FIG. 3, the print module 44 of the data processing device 40 further includes a photo sensor (not shown in FIG. 3) for sensing the material of a print paper placed on the print module 44. When the material of the print paper fits the requirement of the print mode mandated by the print command, printing continues, otherwise a notice message is prompted to warn the user to allow printing continuing or canceling. In an embodiment, the print module 44 senses that the material of a print paper does not fit the requirement of the print mode mandated by the print command, a notice message will be promptly shown on the user interface to warn the user to allow printing continuing or canceling. Certainly, when the user receives the notice message, he/she can replace the print paper by one appropriate for printing.

In another embodiment, the display unit 52 is a light emitting diode installed on the user interface of the data processing device 40, and the single smart button is installed on the user interface of the data processing device 40. The user can activate the automatic outputting function by the single smart button. Then, when the print module 44 senses that the material of the print paper does not fit the requirement of the print mode mandated by the print command, the notice message is prompted to warn the user by glittering of light emitting diode.

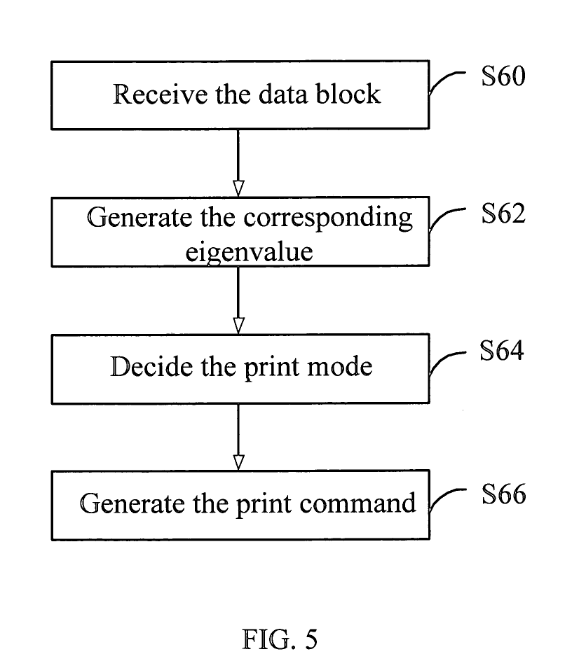

Please refer to FIG. 5. FIG. 5 is a flowchart of the data processing method according to the present invention. The data processing method of the present invention is used for utilizing a data outputting unit to automatically print out a data block in one of a plurality of predetermined print modes. Each of the print modes corresponds to different print quality. As shown in FIG. 5, the data processing method includes the following steps. At start, step S60 is performed to receive the transmitted at least one data block. Afterward, step S62 is performed. In step S62, a corresponding eigenvalue is generated according to at least one data characteristic of the data block. Step S64 is then performed. In step S64, the generated eigenvalues are calculated with a set of corresponding weights to decide a print mode. Step S68 is then performed, a print command is generated to make the data outputting unit print out the data block in the print mode mandated by the print command.

In an embodiment, the data processing method of the present invention is applied in the data processing device 10 as shown in FIG. 1. A to-be-scanned document is scanned by the scanning module, i.e. the data capturing unit 12, and then transformed into the data blocks. The data outputting unit 16 is a print module. In the data processing method of the present invention, the user interface 20 is used for receiving the setting inputted by a user. The user interface 20 includes a single smart button 22. When the user presses the single smart button 22, the automatic outputting function is activated without other complex setting procedure on the user interface 20. After the automatic outputting function is activated, the scanning module scans the to-be-scanned document and transforms it into the data block. After the automatic outputting function is activated, the data processing method of the present invention calculates the data block and automatically generates the print command, so that the print module prints out the data block in the print mode mandated by the print command. The data processing method of the present invention can avoid performing complex setting procedures to print something via the user interface 20. Accordingly, it's very simple and convenient for the user to print something.

In the data processing method of the present invention, an automatic outputting function includes an eigenvalue calculation procedure and a weight calculation procedure. Accordingly, a calculation result P corresponding to the data block can be generated. In the steps S62 through S68 shown in FIG. 5, the calculation result P is generated by performing the eigenvalue calculation procedure and the weight calculation procedure. The print mode can be determined after comparing the calculation result P with the thresholds. As for the eigenvalue calculation procedure, the weight calculation procedure, and the calculation result P, the detailed description has been mentioned in the above, and the related description is neglected.

In an embodiment, the print modes include a draft mode, a normal mode, and a photo mode from low print quality to high print quality. The calculation result P is compared with a first threshold and a second threshold to determine that the data block should be printed out in which print mode.

A to-be-scanned document can be scanned and transformed into at least one data block. The data processing method of the present invention can issue different print commands, so that the print module can print out the data blocks with different calculation result P in different print mode in a flexible manner.

In an embodiment, the data processing method of the present invention is applied in the data processing device 10 shown in FIG. 1. In this embodiment, the data outputting unit further includes a photo sensor 18 for sensing the material of a print paper placed in the data outputting unit. The data outputting unit 16 can sense the material of the print paper and determine whether the material of the print paper fits the requirement of the print mode mandated by the print command. If the material of the print paper does not fit the requirement of the print mode mandated by the print command, a notice message is prompted to warn the user to allow printing continuing or canceling.

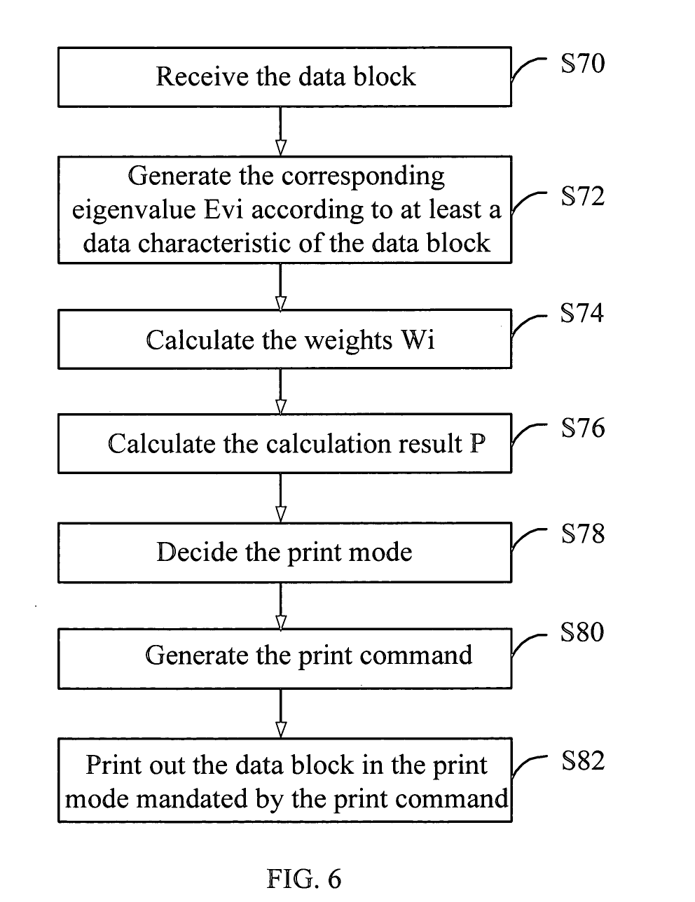

Please refer to FIG. 6. FIG. 6 is a flowchart of the data processing method according to another embodiment of the present invention. In another embodiment, the data processing method of the present invention is used for utilizing a data outputting unit to print out a data block in one of a plurality of predetermined print modes. In this embodiment, the predetermined print modes include a draft mode, a normal mode, and a photo mode, and these print modes respectively correspond to different print quality. The print quality from low to high can be separated into three intervals by two thresholds T1 and T2. The draft mode corresponds to the lower print quality, and the photo mode corresponds to the higher print quality, as shown in FIG. 4.

As shown in FIG. 6, the data processing method of the present invention includes the following steps. At start, step S70 is performed to receive a data block. Afterward, step S72 is performed. In step S72, a corresponding eigenvalue is generated according to at least one data characteristic of the data block. In this embodiment, four eigenvalues respectively are the eigenvalue of transmittance EV1, the eigenvalue of the chroma EV2, the eigenvalue of the graphics-to-text ratio EV3, and the eigenvalue of the material of the print paper EV4. Step S74 is then performed. In step S74, four weights W1, W2, W3, and W4 respectively corresponding to the four eigenvalues EV1, EV2, EV3, and EV4 are calculated. Step S76 is then performed. In step S76, a calculation result P is calculated, wherein P=W1EV1+W2EV2+W3EV3+W3EV3. Step S78 is then performed. In step S78, the calculation result P is compared with the thresholds T1 and T2 to determine the print mode. If P is smaller than T1, the data block will be printed out in the draft mode, if P is smaller than T2 and larger than T1, the data block will be printed out in the normal mode, and if P is larger than T1, the data block will be printed out in the photo mode. Step S80 is then performed. In step S80, a print command corresponding to the mandated print mode is generated. Step S82 is then performed. In step S82, the data block is printed out in the print mode mandated by the print command.

In the data processing method of the present invention, the data block can be a document or a file processed by a scanner, a printer, a fax, a multifunction printer, or a combination thereof. Furthermore, the data also can be also a file in the computer. In addition, nowadays there are two or more than two functions in the same multifunction printer, such as scanning, printing, faxing, or copying, etc. For example, the best print mode can be generated automatically to copy and print data through the flowchart shown in FIG. 6. If a user does not activate the automatic outputting function, the data will be copied and printed in default print mode or by the procedure set himself/herself.

Compared to the prior art, the data processing device and method of the present invention can be used for, according to the data characteristics of the data blocks, automatically deciding the best print mod for the data blocks transmitted from a scanner, a printer, a fax, a multifunction printer, a computer, or the like. According to the data blocks with different calculation result on the same document or file, the data processing device of the present invention can issue different print command to print out the data blocks with different calculation result in different print mode in a flexible manner. Furthermore, the user only need to press the smart button to activate the automatic outputting function, so that the best print mode can be automatically decided. Moreover, the data processing device and method of the present invention can automatically sense the material of the print paper and determine whether the material fits the requirement of the print mode. Afterward, a notice message is further prompted to warn the user. The data processing device and method thereof can automatically decide the best print mode in a flexible manner according to the data characteristics of the document or file without other complex setting procedures. Therefore, the present invention can avoid consuming the printing resources and wasting time. Accordingly, it's more convenient for the user, and the best print mode can be obtained automatically.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A data processing device comprising:
a data processing unit for receiving a transmitted data block and generating a corresponding eigenvalue according to at least one data characteristic of the data block; and
a data outputting unit comprising a plurality of predetermined print modes for printing the data block in a print mode according to a print command transmitted from the data processing unit;
wherein the data processing unit calculates the generated eigenvalues with a set of corresponding weights to automatically generate the print command, so that the data outputting unit prints out the data block in the print mode mandated by the transmitted print command.

2. The data processing device of claim 1, wherein the data processing device further comprises a data capturing unit for capturing the data block and for transmitting the data block to the data processing unit.

3. The data processing device of claim 2, wherein the data capturing unit is a scanning module for scanning and transforming a to-be-scanned document into at least one of the data blocks.

4. The data processing device of claim 3, wherein the data outputting unit is a print module.

5. The data processing device of claim 4, wherein the data processing device further comprises a user interface for receiving a selection setting inputted by a user, wherein the user interface comprises a single smart button and an automatic outputting function is activated when the smart button is pressed without having to perform other settings in the user interface, and wherein when the automatic outputting function is activated, the scanning module promptly scans and transforms the to-be-scanned document into the data blocks and the data processing unit performs calculation on the data blocks to automatically generate the print command, so that the print module prints out the data blocks according to the print mode mandated by the print command and, so as to avoid complex setting procedures in the user interface.

6. The data processing device of claim 5, wherein the data characteristic comprises transmittance, chroma, or graphics-text ratio of the data block, and material of a printing paper.

7. The data processing device of claim 6, wherein the automatic outputting function comprises:
an eigenvalue calculation procedure, based on transmittance, chroma, or graphics-text ratio of the data block, and material of the printing paper, for calculating the corresponding eigenvalue EVi (i=1˜N) respectively, wherein N represents the number of the eigenvalues; and
a weight calculation procedure, for calculating the corresponding weights Wi (i=1˜N) respectively based on the formula
$$Wi = EVi / {\sum }_{i = 1}^{N} EVi ;$$
wherein a calculation result P corresponding to the data block is obtained based on the formula
$$Wi = EVi / {\sum }_{i = 1}^{N} EVi ,$$
and the calculation result P is compared with at least one threshold, so as to determine the print mode and generate the print command, and the data processing unit prints out the data block according to the print mode mandated by the print command.

8. The data processing device of claim 7, wherein the eigenvalue calculation procedure comprises an AutoType algorithm for determining whether the data block is classified as color, gray, or black/white based on a preview image data of the scanning module, and wherein a Lebesgue algorithm is further employed to determine whether the data block is classified as color based on a data density and a Erosion algorithm is further employed to determine whether the data block is classified as gray or black/white.

9. The data processing device of claim 7, wherein different print modes correspond to different print quality, and the print modes comprise a draft mode, a normal mode, and a photo mode from low print quality to high print quality, and wherein the calculation result P is compared with a first threshold and a second threshold to determine whether the data block is to be printed out in the draft mode, the normal mode, or the photo mode.

10. The data processing device of claim 3, wherein the data processing unit issues different print commands for different data blocks with different calculation results P in the same to-be-scanned document, so that the data outputting unit prints out different data blocks with different calculation results P in different print modes in a flexible manner.

11. The data processing device of claim 1, wherein the data outputting unit further comprises a photo sensor for sensing the material of the printing paper in the data outputting unit, and wherein when the material of the printing paper fits the requirement of the print mode mandated by the print command, printing continues, otherwise, a notice message is prompted to warn the user to allow printing continuing or canceling.

12. The data processing device of claim 1, wherein the data processing device is a scanner, a printer, a fax, and a multi-function printer (MFP) or combination thereof.

13. A data processing method for utilizing a data outputting unit to automatically print out a data block in a plurality of predetermined print modes, the method comprising the steps of:
receiving at least one transmitted data block;
generating a corresponding eigenvalue based on at least one data characteristic of the data block;
calculating the generated eigenvalue with a set of corresponding weights to determine a print mode accordingly; and
generating a print command to make the data outputting unit print out the data block according to the print mode mandated by the print command.

14. The data processing method of claim 13, wherein the data processing method further utilizes a scanning module for scanning and transforming a to-be-scanned document into at least one of the data blocks.

15. The data processing method of claim 14, wherein the data outputting unit is a scanning module; the data processing method further utilizes an user interface for receiving a selection setting inputted by a user, and wherein the user interface comprises a single smart button and an automatic outputting function is activated when the smart button is pressed without having to perform other setting in the user interface, and wherein when the automatic outputting function is activated, the scanning module promptly scans and transforms the to-be-scanned document into the data blocks and the data processing unit performs calculation on the data blocks to automatically generate the print command, so that the print module prints out the data blocks according to the print mode mandated by the print command and, so as to avoid complex setting procedures in the user interface.

16. The data processing method of claim 15, wherein the automatic outputting function comprises:
an eigenvalue calculation procedure, based on transmittance, chroma, or graphics-text ratio of the data block, and material of the printing paper, for calculating the corresponding eigenvalue EVi (i=1˜N) respectively, wherein N represents the number of the eigenvalues; and
a weight calculation procedure, for calculating the corresponding weights Wi (i=1˜N) respectively based on the formula
$$Wi = EVi / {\sum }_{i = 1}^{N} EVi ;$$
wherein a calculation result P corresponding to the data block is obtained based on the formula
$$Wi = EVi / {\sum }_{i = 1}^{N} EVi ,$$
and the calculation result P is compared with at least one threshold, so as to determine the print mode and generate the print command, and the data processing unit prints out the data block according to the print mode mandated by the print command.

17. The data processing method of claim 16, wherein the eigenvalue calculation procedure comprises an AutoType algorithm for determining whether the data block is classified as color, gray, or black/white based on a preview image data of the scanning module, and wherein a Lebesgue algorithm is further employed to determine whether the data block is classified as color based on a data density and a Erosion algorithm is further employed to determine whether the data block is classified as gray or black/white.

18. The data processing method of claim 16, wherein different print modes correspond to different print quality, and the print modes comprise a draft mode, a normal mode, and a photo mode from low print quality to high print quality, and wherein the calculation result P is compared with a first threshold and a second threshold to determine whether the data block is to be printed out in the draft mode, the normal mode, or the photo mode.

19. The data processing method of claim 14, wherein the data processing unit issues different print commands for different data blocks with different calculation results P in the same to-be-scanned document, so that the data outputting unit prints out different data blocks with different calculation results P in different print modes in a flexible manner.

20. The data processing method of claim 13, wherein the data outputting unit further comprises a photo sensor for sensing the material of the print paper in the data outputting unit, and wherein when the material of the printing paper fits the requirement of the print mode mandated by the print command, printing continues, otherwise, a notice message is prompted to warn the user to allow printing continuing or canceling.
